(19) United States
(12) Patent Application Publication
(10) Pub. No.: US 2016/0252047 A1
(43) Pub. Date: Sep. 1, 2016

(54) DIFFERENTIAL THERMODYNAMIC MACHINE WITH A CYCLE OF EIGHT THERMODYNAMIC TRANSFORMATIONS, AND CONTROL METHOD

(71) Applicant: ABX ENERGIE LTDA, Curitiba, Parana (BR)

(72) Inventor: Marno Iockheck, Curitiba (BR)

(21) Appl. No.: 15/030,080

(22) PCT Filed: Oct. 16, 2014
(86) PCT No.: PCT/BR2014/000381

§ 371 Date: Apr. 18, 2016

(30) Foreign Application Priority Data
Oct. 16, 2013 (BR) BR1020130266345

(51) Int. Cl. F02G 1/05; F02G 1/055

(52) U.S. Cl. CPC F02G 1/05; F02G 1/055; F02G 2250/09; F02G 2270/90

(57) ABSTRACT

The present invention refers to the technical field of thermodynamic engines, and more specifically to a heat engine that operates with gas in closed loop in differential configuration which is characterized by performing a thermodynamic cycle eight transformations or otherwise explain, it performs two thermodynamic cycles simultaneously, each with four interdependent, additional transformations, two of these transformations “isothermal” and two “adiabatic” in mass transfer in phases of adiabatic processing to provide a new performance curve no longer dependent solely on temperature but the mass transfer rate which allows the construction of machines with high yields and low thermal differentials.

The present invention refers to the technical field of thermodynamic engines, and more specifically to a heat engine that operates with gas in closed loop in differential configuration which is characterized by performing a thermodynamic cycle eight transformations or otherwise explain, it performs two thermodynamic cycles simultaneously, each with four interdependent, additional transformations, two of these transformations “isothermal” and two “adiabatic” in mass transfer.

This machine operates in accordance with the principles of thermodynamics, specifically according to the fundamentals of Nicolas Léonard Sadi Carnot, or commonly “Carnot” whose stated secular and accepted in the scientific community does not change, “To be continued conversion of heat work, a system must perform cycles between hot and cold sources, continuously. In each cycle, is withdrawn a certain amount of heat from the hot source (useful energy) which is partially converted into work, the remainder being rejected to the cold source (energy dissipated)”

At present, the world's needs for energy and mechanical tensile strength became challenges whose solutions has brought devastating climate implications. The studies by international organizations such as the UN reveal impacts of extreme gravity to the planet. The use of fossil fuels, oil, gas, coal, of which depend on the world economy, is causing global warming, reduction of polar ice sheets, climate change, high concentrations of gases that produce the greenhouse effect, among other problems. Other energy sources, such as nuclear, used by most developed nations in turn are subject to lead to serious accidents by failures of various orders, among these are the very climate changes that enhance events such as storms, hurricanes, among others.

In the last two hundred years, it has been invented various heat engines for use in industry and to generate power for the population, the most known technologies and economically viable to date are:

Rankine cycle machines, created in 1859 by William John Macquorn Rankine machines used in jets and in generating energy operate the Brayton cycle, created in 1872 by George Brayton, proposed earlier in 1791 by John Barber, used as energy source also materials derived from fossil fuels, kerosene, gas. Internal combustion engines used in automobiles operate at Otto cycle developed by Nikolaus Otto 1876 also uses fossil fuels, gasoline, nowadays also vegetable origin alcohol. Internal combustion engines used in heavy vehicles, trucks, trains, ships and industrial applications, operating by the Diesel cycle, developed by Rudolf Diesel in 1893, also uses fossil fuels, diesel oil, now also of plant origin, biodiesel. External combustion engines, currently used in projects of alternative energy, operate the Stirling cycle developed by Robert Stirling in 1816, uses various energy sources, currently focused on cleaner sources and less environmental impact, such as biomass, hot springs, thermosolar.

All the technologies presented above are heat engines with thermodynamic cycles of four transformations and all of them are references, i.e. its thermodynamic cycle are referenced to the neighborhood and this is the environment, which can be the atmosphere, the space in which they are, for example: the internal combustion engines, after the completion of work on a mechanical force element, piston, turbine, gases are released to the environment, so the forces of the gases push the driving force elements going towards their respective neighborhoods, i.e. the environment. In the case of Stirling engines, its thermodynamic cycle of four transformations, two isotherms and two isochoric occurs with gas always confined in the same environment and the driving force occurs through the displacement of an element, e.g., a piston against its neighborhood, the external environment or other pressurized or vacuum chamber.

Among the heat engines of closed loop, those similar to the present technology for this reason, i.e. only be closed loop are the Stirling machines, there is Alfa type engines such as those published in U.S. Pat. No. 7827789 and US20080282693 patent type beta as the patent US20100095668, Gamma as the patent US20110005220, Stirling Rotating machines such as U.S. Pat. No. 6,195,992 and U.S. Pat. No. 6,996,983 patent, hybrid Wankel-type Stirling as U.S. Pat. No. 7,549,289 and other references as: The PI0515980-6 which is a method with Stirling principle, the PI0515988-1, as is a method with Stirling principle, WO03018996 A1, which is a rotating Stirling cycle machine, WO2005042958 A1, a machine Stirling type Beta cycle, WO2006067429A1 a Stirling cycle engine free piston, the WO2009097698A1, is a method to heat engine modified Carnot cycle, WO2009103871A2, which is a Stirling cycle engine or Carnot, the WO2010048113A1 a balanced Stirling cycle machine, WO201006213A2, defined as a Stirling cycle heat engine, the WO2011005673A1, which is a Stirling cycle engine of Gamma type. All references define models, methods and innovations in thermal machines of closed loop of Stirling cycle, which is two isotherms and two isochoric transformations occurring one after the other sequentially.

On the other hand, the technology described in the present description presents a closed circuit machine, but it is not comprised of a cycle of four transformations, but by a new concept in one configuration the differential so that it performs an eight processing cycle, where in pairs, two by two, with mass transfer, maintaining and following the concepts of thermodynamics, Carnot, but it obliges to consider the weight variation in the equations, providing a possibility not considered in the current thermal machines, i.e. concept of this technology offers a new condition that influences the performance, allowing the most efficient machine design where the income limit no longer requires the sole and exclusive dependence on temperature, but considers the mass transfer rate between the chambers conversion so that the income equation is replaced by a new factor.

The innovations presented in this patent text are evolutions of previous patents, PI000624-9 called “Thermomechanical Energy Converter” and BR1020120155540 called “Thermal machine that operates in compliance with the Thermodynamic Cycle of Carnot” written by the same author of this patent.

The technology developed, subject of this patent text, does not address an ideal machine without loss, however it is a machine capable of performing high-precision differential mode the eight transformations of thermodynamic cycle from a heat source of any kind, accordingly, it has key features currently desired for designs of machines for driving force or power generation plants. The same brings benefits of practical application and economic and as each design, power ranges and characteristics of heat sources, could perform very high yields, surpassing the performance of most other machines considered high performance, for not having their income dependent only on temperature.

Another objective of particular importance is the use of this technology in flexible power generation plants as the thermal sources economically viable income in relation generated power versus heat source and with minimal environmental impact, such as the use of clean heat sources such as solar, thermo, low environmental impact such as biofuels and economic as the use of waste and pre-existing plants where it operates by heat loss, making cogeneration systems, or added to other technologies forming more complex processes called combined cycle for example forming Brayton-Differential Combined cycle systems, using as a heat source gases at high temperatures released by the Brayton cycle turbines, Rankine-differential whose heat source is steam outputs of the last stages of steam turbines and gas chimneys, diesel-differential whose heat source is the cooling fluid the diesel engine, Otto-differential whose heat source is the cooling fluid the Otto cycle engine, among others, significantly broadening the performance as that the processes of thermal machines Brayton cycle, Rankine, Diesel, Otto, have many thermal losses impossible to be taken advantage of by their own dependent thermodynamic cycles of high temperatures, requiring alternative more efficient systems for this use.

To facilitate the understanding of this technology, equations shall be presented, statements that support and maintain the patent, drawings and graphics which shall allow a full understanding of the proposal.

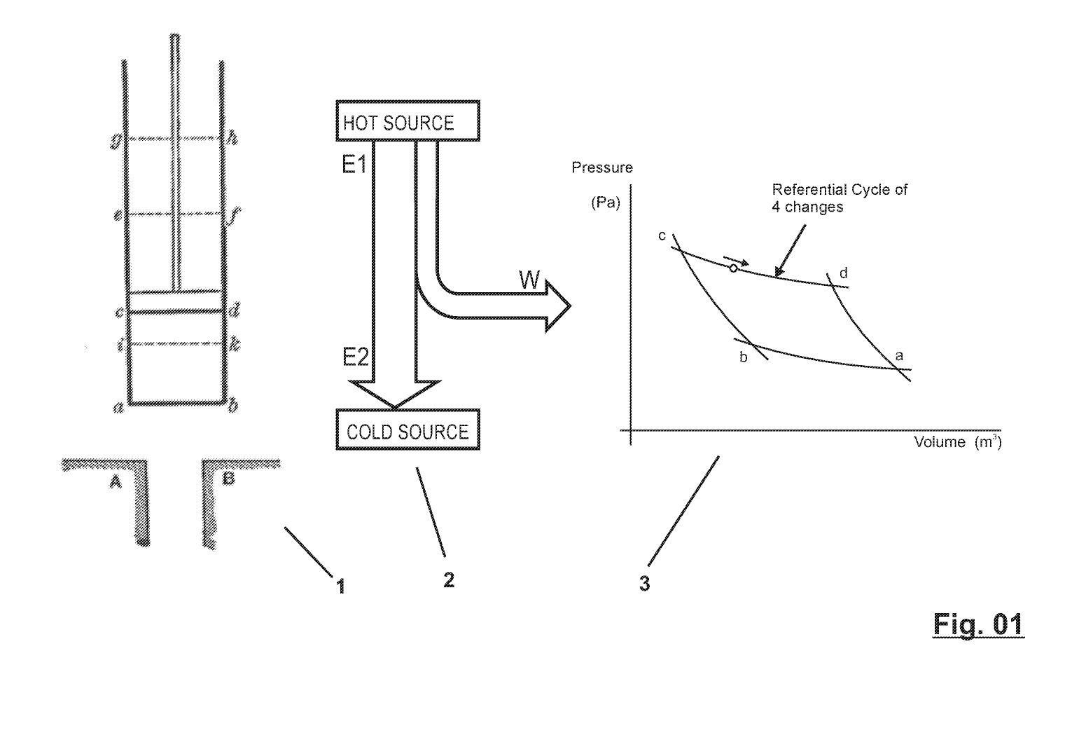

In FIG. 01 is shown the original machine of Carnot (1), the flow diagram of Carnot engine and other heat engines operating on the four thermodynamic transformations ring (2), the cycle graph of Carnot engine with its four transformations (3).

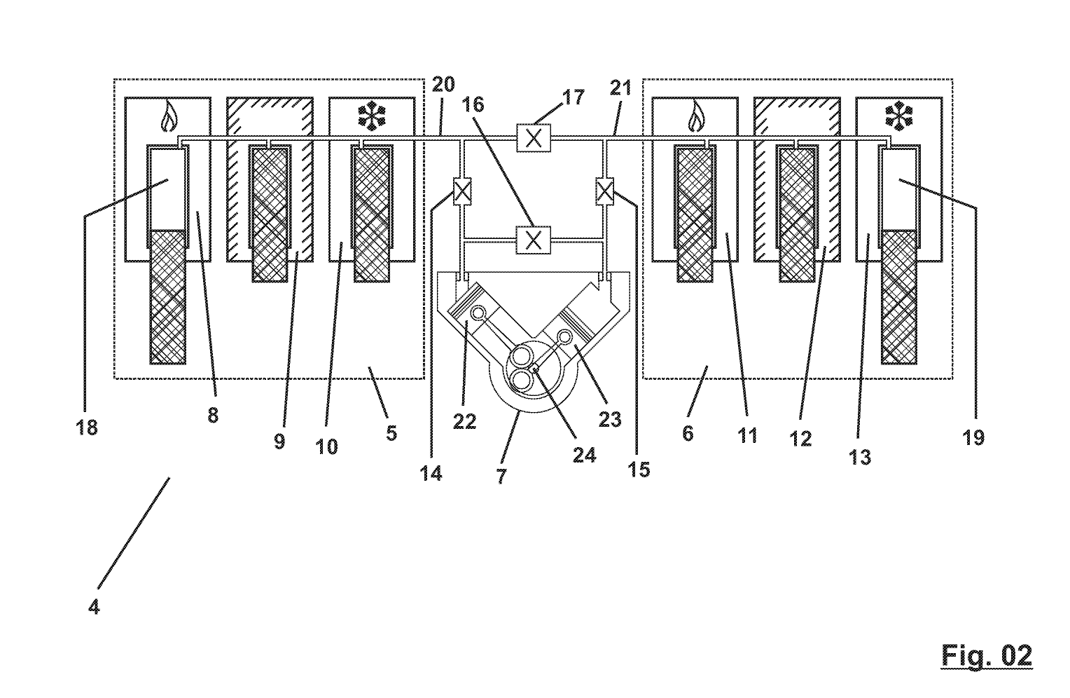

In FIG. 02 is shown Differential machine (4) comprised by two chambers thermodynamic transformations (5) and (6), each chamber with three sections, respectively (8), (9), (10) and (11) (12), (13), each section has its movable piston, controllable, each chamber with a gas volume (18) and (19), channels for the working gas flow (20) and (21), transfer element of gas mass (17), control valve assembly (14) and (15) valve to release the inertial operation of the driving force element (16), driving force element (7), pistons of element of driving force (22) and (23), crankshaft type of element of driving force (24).

Cameras with three sections can be constituted in various ways, are already in the art, can be by pistons, as exemplified, we used this model to facilitate the understanding of the technology described herein can be in the form of disks contained in a housing ring which back advantages for pressure equalization, item contained in the prior art, as well as actuators to move the pistons or chambers of three sections, which may be electrically via motors, servomotors, pneumatic or even by direct mechanical means.

The working gas never changes the physical state in any of the eight transformations of the cycle, always in gaseous state and can be chosen according to the project due to its properties, the main ones are the Helio gas, hydrogen, neon, nitrogen and dry air of the atmosphere.

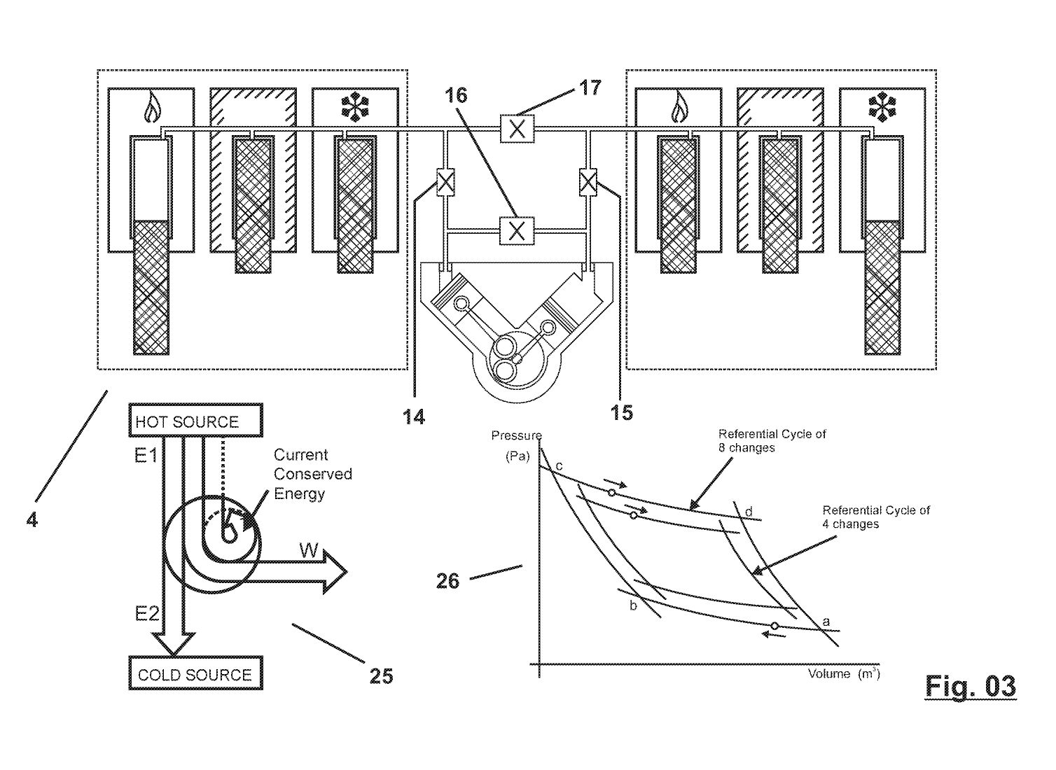

In FIG. 03 is shown again differential machine (4), the heat flow diagram of the differential engine (25) and the comparative graph of the thermodynamic cycle of the differential machine and the Carnot machine (26).

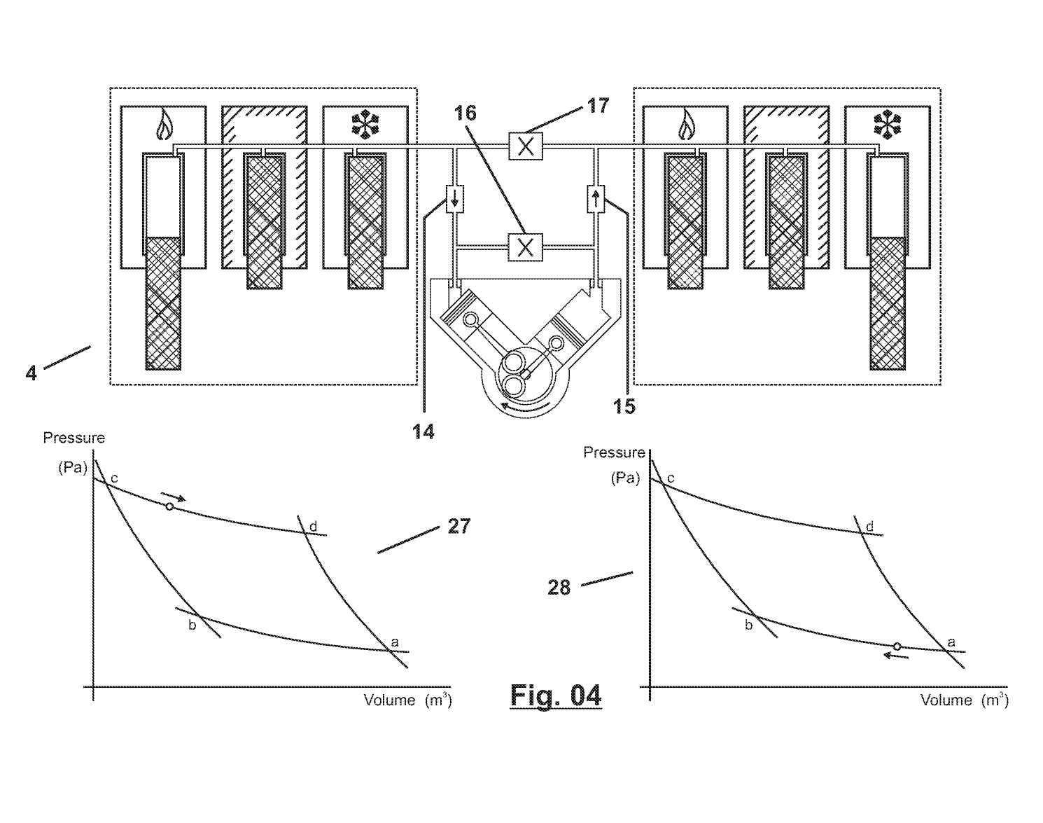

In FIG. 04 is shown the differential engine (4) with a chamber containing the working gas in the heated section performing a isothermal transformation high temperature shown in the graph (27) while the other chamber containing the working gas also in the refrigerated section performing a low isothermal transformation temperature shown in the graph (28). These changes occur a referenced to the other, and therefore is called “Differential”. In this phase, the elements of mass transfer (17) and valve to release the inertial operation of the driving force element (16) are closed, the control valve (14) and (15) are open allowing the realization of working gas on the element of the driving force (7).

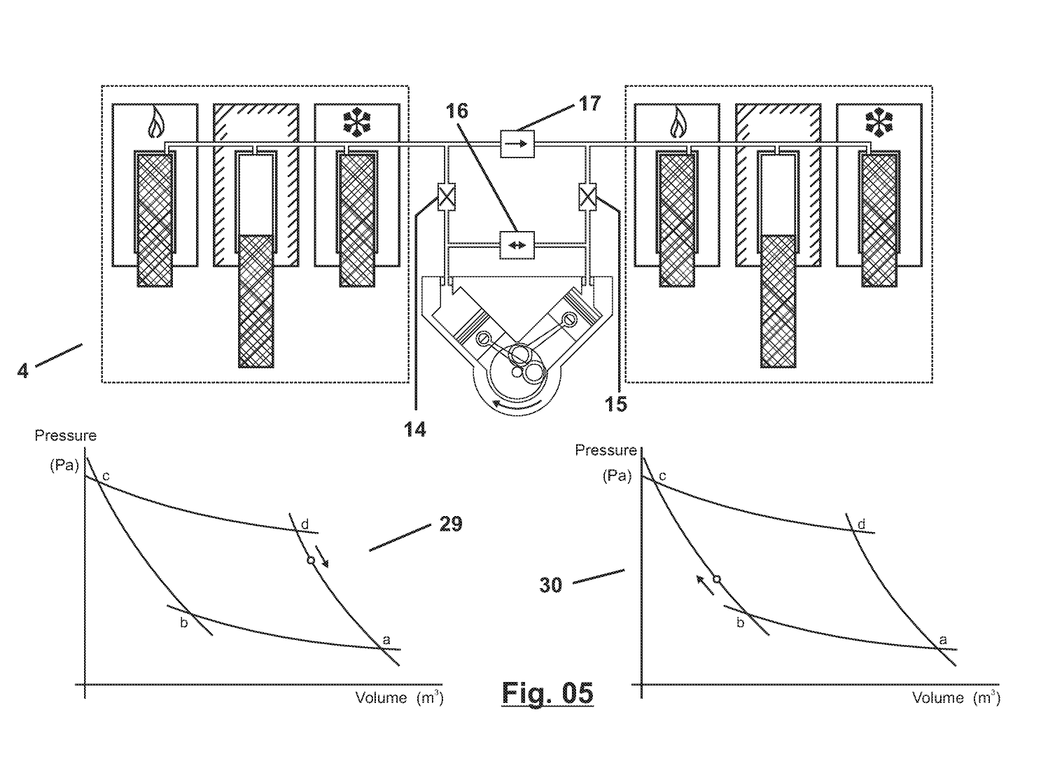

In FIG. 05 is shown the differential engine (4) with a chamber containing the working gas in the isolated section performing its adiabatic transformation expansion (29) with mass transfer to the second chamber, while the other chamber also containing working gas in isolated section performing processing also adiabatic, but compression (30), receiving working gas of the first chamber. In this phase, the element of mass transfer (17) performs the transfer of gas particles from the first chamber, high temperature, into the second chamber, the low temperature valve to release the inertial operation of the element of driving force (16) open allowing the continuity of crankshaft rotation (24) of the element of driving force (7), control valves (14) and (15) are closed to meet the adiabatic processes.

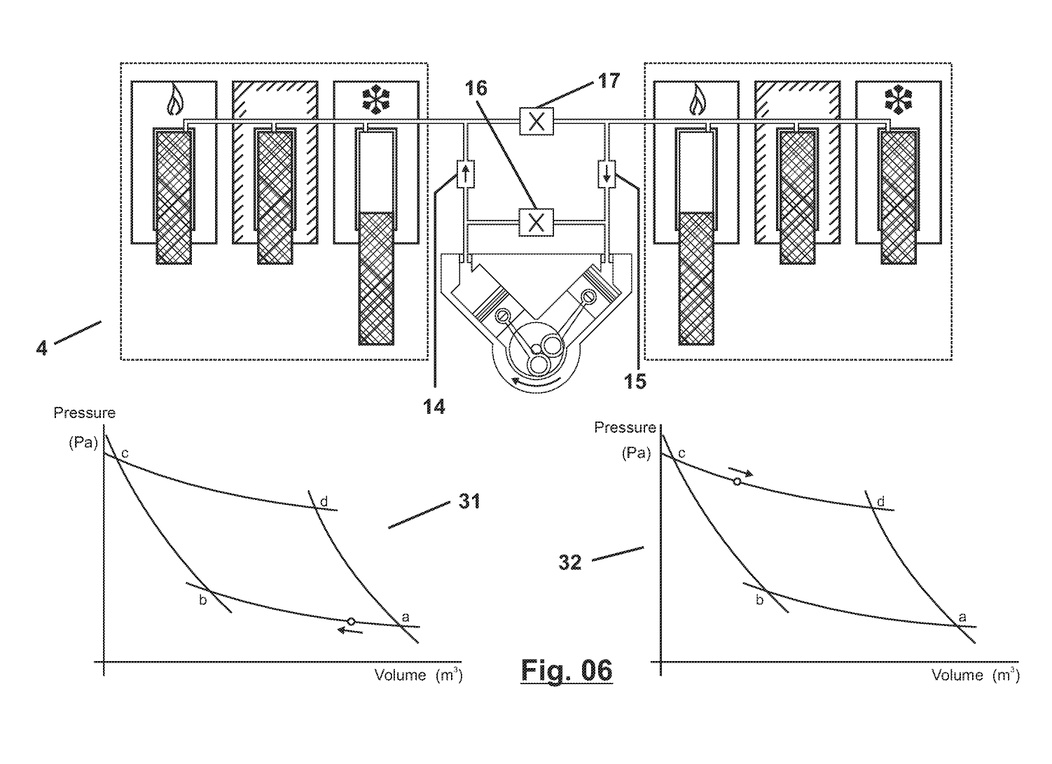

In FIG. 06 is shown the differential engine (4) now with the first chamber containing the working gas in the cold section performing a isothermal transformation of low temperature shown in the graph (31) while the other chamber in turn also containing gas work in section performing a heated isothermal transformation high temperature shown in the graph (32). In this phase, the elements of mass transfer (17) and valve to release the inertial operation of the element of driving force (16) are closed, the control valve (14) and (15) are open allowing the realization of working gas on the element of driving force (7).

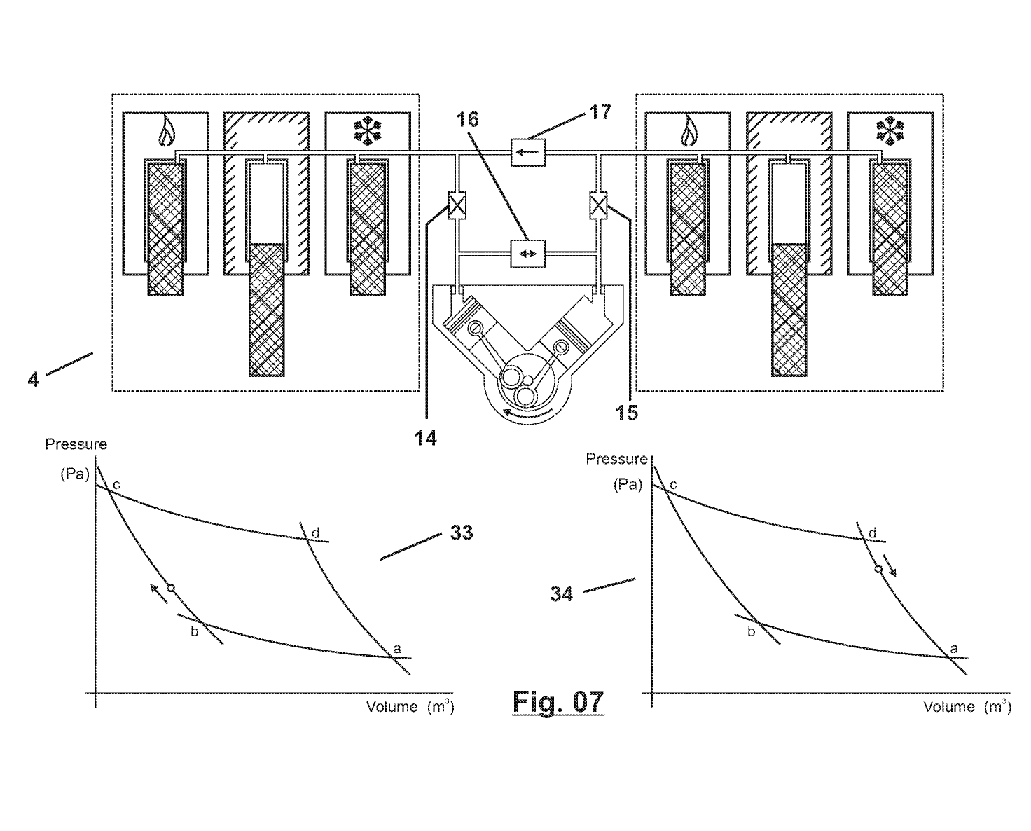

In FIG. 07 is shown the differential engine (4) with a chamber containing the working gas in the isolated section performing its adiabatic transformation expansion (33) with mass transfer to the second chamber, while the other chamber also containing working gas in isolated section performing processing also adiabatic, but compression (34), receiving working gas of the first chamber. In this phase, the element of mass transfer (17) performs the transfer of gas particles from the first chamber, high temperature, into the second chamber, the low temperature valve to release the inertial operation of the element of driving force (16) open allowing the continuity of crankshaft rotation (24) of the element of driving force (7), control valves (14) and (15) are closed to meet the adiabatic processes.

Observing the process described above, it is obvious to understand that the differential configuration with mass transfer, the isothermal transformation high temperature gas shall always have more particles than the low-temperature isothermal transformation.

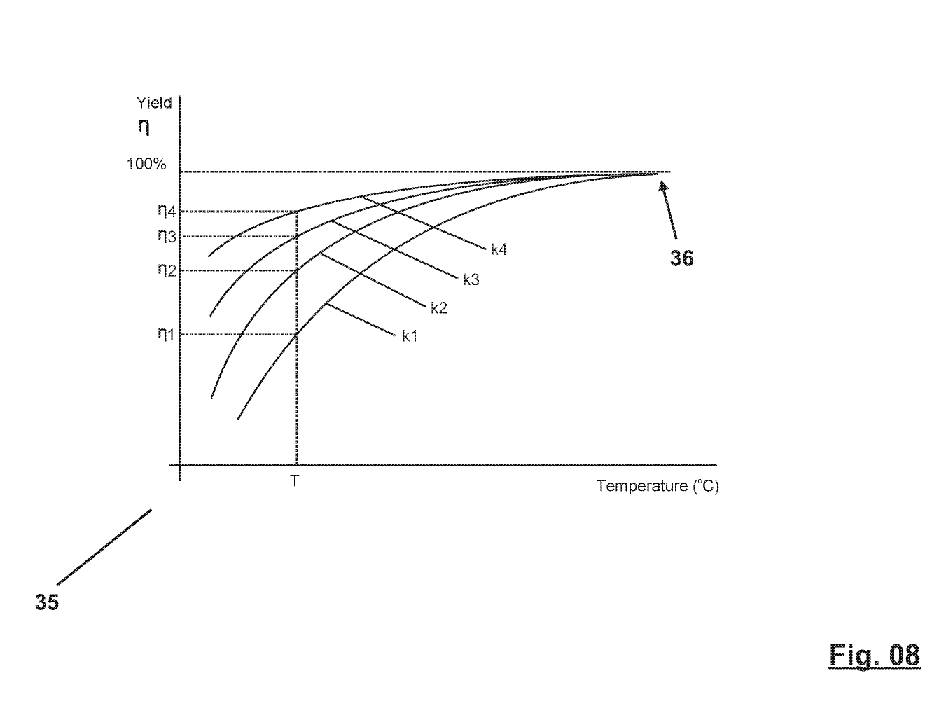

In FIG. 08 is shown the performance graph of the “Thermal Differential Machine with Eight Thermodynamic Changes with Transfer of gas mass between chambers for different transfer rates of gas mass, to be explained in this text of patent of invention.

The fundamentals of this technology shall initially be demonstrated from the presentation of the original yield equation of Carnot:

$$η = 1 - \frac{{T}_{2}}{{T}_{1}}$$

This equation is well known in the scientific community, it is accepted and used as reference level for obtaining the efficiency of a heat engine. It is based on the original design conceived by Carnot and shown in FIG. 01 in (1), the FIG. 01 in (2) the heat flow diagram of the Carnot engine is indicated, making it clear that there is a hot spring where there is the heat and the flow goes E1, part generates the work W and the remainder goes to the cold source E2. The thermodynamic cycle is reference of four transformations shown in (3) still in FIG. 01, comprises two s isotherms and two adiabatic changes.

In the above equation, T₂ is the temperature of the cold source and the temperature T₁ of the hot source, and the performance of this machine is likely to 100% at the boundary T₂ which tends to “zero”.

There is no doubt that the Carnot fundamentals are correct, as there is no doubt about the income limits governed by the idealized formula above. However, the known machines are designed to perform their mechanical and thermodynamic cycle reference mode, or perform work and thermodynamic reference changes to its surroundings, the atmosphere when applied in our environment, the vacuum in the space or referenced to a chamber under certain fixed condition. The work of Nicolas Léonard Sadi Carnot considers these references as they are and the yield equation regarding these references.

Leaving the line of reasoning, references of existing models, keeping the same foundations of Carnot, the new heat engines may be designed in a differential configuration. Thus, the thermodynamic cycles do not occur with reference to the means, but with reference to another thermodynamic cycle simultaneously and out of phase manner and all calculations shall be a reference to another, creating new possibilities.

In FIG. 02 is presented the “Thermal Differential Machine with Eight Changes with Transfer of mass between chambers”.

In FIG. 02, (5) indicates a chamber composed of three sections, a heated, an isolated and cooled, the gas will always occupy only one of the sections in each of the thermodynamic transformations. In this camera is processed four of the eight changes occurring in the same cycle, the gas during each phase of processing sections is transported through the pistons shown in the same figure. In the same figure, in (6) is shown another chamber, identical to the first, which handles the other four transformations completing the thermodynamic cycle eight transformations, both are connected to each other in a differential configuration through the ducts (20) and (21), being between them an element of driving force (7), a transfer element of gas mass (17), a set of control valves (14) and (15), a valve to release the inertial operation of the element of the driving force (16). The driving force element comprises pistons (22) and (23) and shaft crankshaft type (24) depending on the characteristics of the system, the driving force element can be different and even be parts of known market, such as turbines, diaphragms, rotors operating on gas flow. In the same figure, the elements (8) and (11) show respectively the heated sections of the chambers (5) and (6), elements (9) and (12) show respectively the isolated sections of the chambers (5) and (6), elements (10) and (13) show respectively sections of the refrigerated chamber (5) and (6),

In the technology presented in this text, the statement of Carnot does not change, “To have continued conversion of heat into work, a system must perform cycles between hot and cold sources, continuously. In each cycle, is withdrawn a certain amount of heat from the hot source (useful energy) which is partially converted into work, the remainder being rejected to the cold source (energy dissipated)”

Thus, the efficiency of a machine configuration with the differential transfer of gas particles, with a thermodynamic cycle of 8 transformations shall be:

$$η = 1 - \frac{1}{k} \cdot \frac{{T}_{2}}{{T}_{1}}$$

Where T₂ is the temperature of the cold source, T₁ the temperature of the hot source and k the particle transfer rate between the chambers, and the performance of this machine tends to 100% in two possible conditions at the boundary where T₂ tends to “zero” and the threshold where 1/k tends to zero, as can be seen in the graph (35), specifically at the point (36) shown in FIG. 08.

The yield of a heat engine is an extremely important factor, along with the operating temperature, both are key factors for power generation, use of alternative sources of low or no environmental impact. Such evidence can be seen in FIG. 08, the curve where k=k1=1 represents the curve of the ideal machine of Carnot, k=1, as the Carnot engine gas always remains in the same compartment, the number of particles never changes on the other hand, in a differential configuration allows to control this condition, making k4>k3>k2>k1=1 and thus, it is possible to obtain a heat engine of high performance with low thermal differential becoming viable projects power plant and power generation based on clean energy sources, renewable like the sun and geothermal, with less environmental impact using organic fuel, and also less harmful to the very use of fossil and nuclear sources simply by producing more power with less fuel consumption.

Physically, the differential cycle of mass transfer consists in the passage of a certain amount of gas particles in the chamber that has completed its isothermal transformation of high to the camera that has completed its isothermal transformation of low, however this transfer occurs during adiabatic transformations causing an extension in curves as shown in the graph (26) of FIG. 03. While one chamber undergoes the effect of pressure drop, reducing the density (increase in volume) observed in (a) of the graph (26), on the other there is increased pressure, increased density, (volume reduction) observed in (c) of the graph (26). This extension of the curve increases the area of the cycle, i.e. the work done.

It is important to note that this is not a Stirling engine, it is not a Carnot engine, both are references, which is presenting is a differential machine. Thermodynamic fundamentals are absolutely the same.

The thermal differential machines perform simultaneous thermodynamic transformations, shown by the arrows in high isothermal (c-d) and low (a-b) the graph (26) of FIG. 03, as they are differential, there are two cameras simultaneously performing their own thermodynamic cycle, but one referring to the other. This property allows the transfer of material between them in order to reduce the power supplied to the cold source.

The fundamentals of differential thermal machines are the same as other thermal machines, and the Carnot machine as a general reference.

Differential machine with cycle of eight thermodynamic transformations performed simultaneously two by two, has a yield which can be mathematically demonstrated as follows:

From the original design of the Carnot engine designed by Nicolas Léonard Sadi Carnot, around 1820, but in a “differential” configuration, as being two machines connected to each other, out of phase by 180°, with mass transfer during adiabatic transformations, the referential of a machine would be not the environment but the other machine, both the mechanical system which performs work, such as the thermodynamic system.

The system formed by these two heat transfer chambers (energy) each perform their own thermodynamic cycle with the particles contained in them. It would be, therefore, an integrated system with two simultaneous thermodynamic cycles, delayed by 180° or a thermodynamic cycle with 8 transformations occurring in pairs, delayed and interdependent because they exchange mass between itself and the expansions are performed on one another alternately and not against the environment.

The mass transfer occurs during the adiabatic processes after the chambers do work against each other in the high-isothermal, the control system would enable the passage of particles through the element (17) of the upper chamber to the lower chamber, to achieve balance of pressures or in forced manner. Thus, fewer gas particles shall be available at low isothermal, reducing the loss of energy to the cold source. This stored energy shall circulate between the two chambers of the machine, shown in the flow diagram (25) of FIG. 03, providing increased efficiency and that fraction of energy can not be used to generate work.

Thus, the output curve of a machine in a differential configuration with an eight processing cycle consisting of isothermal and adiabatic with mass transfer is more efficient than a machine reference configuration Carnot, although the limit with the temperature T₂ tending to “zero”, both have the same yield shown in FIG. 08.

According to the same grounds of Carnot:

Power input c-d:

E1≦W_{c-d}=∫P.dV

The general equation of gases:

$$P = \frac{{n}_{1} \cdot R \cdot {T}_{1}}{V}$$

$${W}_{c - d} = {\int }_{{V}_{c}}^{{V}_{d}} \frac{{n}_{1} \cdot R \cdot {T}_{1}}{V} d V$$

$${W}_{c - d} = {n}_{1} \cdot R \cdot {T}_{1} \cdot ln ( V ) {/}_{{V}_{c}}^{{V}_{d}} \\ {W}_{c - d} = {n}_{1} \cdot R \cdot {T}_{1} \cdot ln ( \frac{{V}_{d}}{{V}_{c}} )$$

And the energy in a-b is represented by:

E2=W_{a-b}=∫P.dV

By general equation of gases:

$$P = \frac{{n}_{2} \cdot R \cdot {T}_{2}}{V}$$

$${W}_{a - b} = {\int }_{{V}_{a}}^{{V}_{b}} \frac{{n}_{2} \cdot R \cdot {T}_{2}}{V} d V$$

$${W}_{a - b} = {n}_{2} \cdot R \cdot {T}_{2} \cdot ln ( V ) {/}_{{V}_{a}}^{{V}_{b}} \\ {W}_{a - b} = {n}_{2} \cdot R \cdot {T}_{2} \cdot ln ( \frac{{V}_{b}}{{V}_{a}} )$$

The total quantity of energy associated to the work is:

W=W_{c-d}+W_{d-a}+W_{a-b}+W_{b-c}

The processes d-a and b-c are adiabatic and internal energy depends only on the temperature, the initial and final temperatures of this process are equal and opposite, the number of exchanged particles is also identical, thus:

W_{d-a}=−W_{b-c}

and

W=W_{c-d}+W_{a-b}

And the performance of the machine in accordance with the principles of thermodynamics in a differential configuration is:

$$η = \frac{{W}_{c - d} + {W}_{a - b}}{{W}_{c - d}}$$

Replacing by work equations:

$$η = \frac{{n}_{1} \cdot R \cdot {T}_{1} \cdot ln ( \frac{{V}_{d}}{{V}_{c}} ) + {n}_{2} \cdot R \cdot {T}_{2} \cdot ln ( \frac{{V}_{b}}{{V}_{a}} )}{{n}_{1} \cdot R \cdot {T}_{1} \cdot ln ( \frac{{V}_{d}}{{V}_{c}} )}$$

Considering that it is a closed system, reversible, the rate:

$$\frac{{V}_{d}}{{V}_{c}} = \frac{{V}_{a}}{{V}_{b}}$$

By properties of logarithms:

$$η = \frac{{n}_{1} \cdot R \cdot {T}_{1} \cdot ln ( \frac{{V}_{d}}{{V}_{c}} ) - {n}_{2} \cdot R \cdot {T}_{2} \cdot ln ( \frac{{V}_{d}}{{V}_{c}} )}{{n}_{1} \cdot R \cdot {T}_{1} \cdot ln ( \frac{{V}_{d}}{{V}_{c}} )}$$

Simplifying:

$$η = \frac{{n}_{1} \cdot {T}_{1} - {n}_{2} \cdot {T}_{2}}{{n}_{1} \cdot {T}_{1}}$$

Then:

$$η = 1 - \frac{{n}_{2} \cdot {T}_{2}}{{n}_{1} \cdot {T}_{1}}$$

Observing now in a differential configuration with particles of gas transfer, not corrupting any of the thermodynamic grounds, the transfer of particles between the chambers in the adiabatic:

n₂<n₁

Making:

$$k = \frac{{n}_{1}}{{n}_{2}}$$

Therefore, the efficiency of a machine configuration with the differential transfer of gas particles, with a cycle of eight transformations, or in other words, two simultaneous and interdependent thermodynamic cycles in accordance with Carnot cycle is:

$$η = 1 - \frac{1}{k} \cdot \frac{{T}_{2}}{{T}_{1}}$$

Where T₂ is the temperature of the cold source and T₁ the temperature of the hot source.

And the performance of this machine tends to 100% in two possible conditions at the boundary where T₂ tends to “zero” and the range where 1/k tends to zero, and then the chart (35) of FIG. 08, and this difference engine eight thermodynamic transformations cycle equals the Carnot machine, which is a machine with four thermodynamic cycle changes in the condition of no mass transfer of gas, that is, only when k=1.

As described above, this invention provides substantial innovation for future energy systems, it has the property to operate with any heat source. Aims its application in power generation plants with the basic source, solar thermal and as complements, thermal sources of geological origin, biofuels and also in special cases or to supplement the fossil fuels and even nuclear. Exemplifying the fields of applications of this technology, as follows:

Large generating plants of electricity using thermosolar sources with concentrators and mirrored collectors, these plants can be designed to power between 10 MW and 1 GW.

Large generating plants having as heat sources the use of heat from the soil depths, obtained by passing a heat transfer fluid to the recycle stream obtaining heat from the depths, transporting it to the surface and, thus, being used in the chambers conversion.

Large generating plants having as a heat source in the combustion biofuel, biomass, waste and other organic waste products.

Large generating plants as a heat source with the use of traditional fossil fuels.

Small and medium-sized generating plants for distributed generation, with the heat source, small solar concentrators or small boilers burning of organic residues or waste residues.

Systems of power generation for spacecrafts, probes and space satellites with solar concentrators as a source of heat or nuclear sources, especially for exploration in deep space. For this application, includes the generation of high-power energy to meet the needs of ion propulsion engines in space.

Systems of power generation submarines AIP like, “Air Independent Propulsion”, with the heat source, fuel cells. Plants of power generation in space objects that have some source of heat, planets, natural satellites and other bodies such as the moon, for example, where heat can come from solar concentrators or thermonuclear sources.

Machines to generate mechanical force of vehicle traction.

We conclude that this is a technology that meets an unusual flexibility and can operate with any heat source, this means that allows projects combustion or simple heat flow, a differential configuration with mass transfer deletes the temperature dependence with performance, allowing high-performance machines, higher than the current, its independence oxygen gives applications for spacecraft and submarines, thus bring benefits in accordance with the standards that are sought in the present and the future.

1. “THERMAL DIFFERENTIAL MACHINE WITH EIGHT CHANGES OF THERMODYNAMIC CYCLE AND PROCESS CONTROL”, comprising two chambers of thermodynamic transformations each with three sections, one heated, an isolated, one cooled, connected in differential configuration through ducts or channels, a power element driving, a mass transfer element of gas, a valve to release the inertial operation of the driving force element and a set of control valves.

2. “THERMAL DIFFERENTIAL MACHINE WITH EIGHT CHANGES OF THERMODYNAMIC CYCLE AND PROCESS CONTROL”, according to claim 1, is characterized by having two cameras working gas each containing three sections, one heated, one isolated a chilled connected in differential configuration, so that operating the same have 3 possible positions in the process while in the first phase in the first chamber the gas is in the heated section, the second chamber it is in the refrigerated section, in the second stage both chambers are in an isolated section, in third phase the first chamber gas is cooled in section, the second chamber is the same in the heated section and in the fourth phase gas again both are in the isolated section, thus providing the eight differential thermodynamic transformations.

3. “THERMAL DIFFERENTIAL MACHINE WITH EIGHT CHANGES OF THERMODYNAMIC CYCLE AND PROCESS CONTROL” according to claim 1, is characterized by having a mass transfer element of gas between the chambers during the adiabatic stages.

4. “THERMAL DIFFERENTIAL MACHINE WITH EIGHT CHANGES OF THERMODYNAMIC CYCLE AND PROCESS CONTROL”, according to claim 1, is characterized by having a driving force element that operates by the working gas forces generated in the processing chamber, connected between the two chambers thermodynamic transformations performing work useful during isothermal transformation and maintaining the movement by inertial force in the adiabatic transformations.

5. “THERMAL DIFFERENTIAL MACHINE WITH EIGHT CHANGES OF THERMODYNAMIC CYCLE AND PROCESS CONTROL” according to claims 1 and 4 is characterized by having a valve for releasing the operation of the inertial element driving force during the adiabatic changes.

6. “THERMAL DIFFERENTIAL MACHINE WITH EIGHT CHANGES OF THERMODYNAMIC CYCLE AND PROCESS CONTROL” according to claim 1, is characterized by having a set of control valves which provides the passage of working gas between the chambers of transformations and elements of the driving force.

7. “CONTROL PROCESS OF DIFFERENTIAL THERMAL MACHINE” according to claims 1 and 2, is characterized by a process carried out by the two chambers containing the working gas endowed with the mass shift control synchronized gas which execute each of both transformations thermodynamics in the following sequence in the first phase are performed isothermal transformation high temperature for the first chamber, while in the other chamber an isothermal low temperature in the second stage are performed an adiabatic processing to expand the first chamber with mass transfer to another chamber, the second chamber an adiabatic transformation mass reception compressing the first gas in the third phase are executed isothermal transformation lower temperature in the first chamber, while in the other a high temperature isotherm in the fourth step are executed a transformation adiabatic compression with mass received by the first chamber, the second chamber an adiabatic expansion processing with gas mass transfer to the first, concluding the thermodynamic cycle eight changes in differential configuration.

8. “CONTROL PROCESS OF DIFFERENTIAL THERMAL MACHINE”, according to claims 1, 2, 3 and 7 is characterized by a process of mass transfer of gas between chambers control phases during adiabatic change.

9. “CONTROL PROCESS OF DIFFERENTIAL THERMAL MACHINE” according to claims 1, 2, 3, 7 and 8 is characterized by a process control which maintains a circulating energy stored within the machine being moved alternately between the two chambers so as to limit the energy discharged into the low-temperature isothermal transformations which eliminates the exclusive dependence on the machine performance with temperature.

10. “CONTROL PROCESS OF DIFFERENTIAL THERMAL MACHINE” according to claims 1, 2, 3, 4, 5, 6, 7, 8 and 9 is characterized by a control process which modulates the eight transformations four of each chamber controlling the whole cycle within the time period, defining a time for isothermal, a time of adiabatic and mass transfer between chambers and thus resulting in full control of the speed, torque and performance of the system.
